(19) United States
(12) Patent Application Publication
(10) Pub. No.: US 2013/0179035 A1
(43) Pub. Date: Jul. 11, 2013

(54) VEHICLE

(71) Applicants: Tsutomu Adachi, Aichi (JP); Shigeru Hayashi, Gifu (JP); Takezumi Kondo, Mie (JP); Tatsumi Kuroda, Mie (JP); Takeo Nozawa, Aichi (JP); Tsuyoshi Kawanishi, Aichi (JP); Hiroshi Maekawa, Aichi (JP)

(72) Inventors: Tsutomu Adachi, Aichi (JP); Shigeru Hayashi, Gifu (JP); Takezumi Kondo, Mie (JP); Tatsumi Kuroda, Mie (JP); Takeo Nozawa, Aichi (JP); Tsuyoshi Kawanishi, Aichi (JP); Hiroshi Maekawa, Aichi (JP)

(73) Assignee: ADC TECHNOLOGY INC., Aichi (JP)

(21) Appl. No.: 13/824,302

(22) PCT Filed: Sep. 22, 2011
(86) PCT No.: PCT/JP2011/071668

§ 371 Date: Mar. 15, 2013

(30) Foreign Application Priority Data
Sep. 24, 2010 (JP) 2010-214142

(51) Int. Cl. G05B 11/32

(52) U.S. Cl. CPC G05B 11/32
USPC 701/36

(57) ABSTRACT

A vehicle includes a detection device and a color change device. The detection device detects an internal state and an external state of the vehicle. The color change device at least partially changes a color of a body of the vehicle depending on a result of detection by the detection device.

### CROSS-REFERENCE TO RELATED APPLICATIONS

This international application claims the benefit of Japanese Patent Application No. 2010-214142 filed Sep. 24, 2010 in the Japan Patent Office, and the entire disclosure of Japanese Patent Application No. 2010-214142 is incorporated herein by reference.

### TECHNICAL FIELD

The present invention relates to a vehicle such as an automobile, and particularly relates to a vehicle in which a color of a body thereof is at least partially changeable.

### BACKGROUND ART

There has been a desire to configure a color of an exterior equipment, etc. for an automobile so that the color can be changed as desired by a driver. In this regard, for example, it has been proposed to provide a cylindrical side molding, which is rotatable around a shaft along an interior surface of the body and an exterior surface of which is colored with multiple colors, and to rotate the side molding to change a part to be exposed from an outer surface of the body, thereby changing a color of the exposed part of the side molding (for example, see Patent Document 1).

### PRIOR ART DOCUMENTS

### Patent Documents

Patent Document 1: Japanese Unexamined Patent Application Publication No. H5-24488

### SUMMARY OF THE INVENTION

### Problems to be Solved by the Invention

However, in the above-described side molding of Patent Document 1, the color of the exposed part is changed by operation of a driver from outside of a vehicle before driving. Accordingly, it is not possible to automatically change the color of the body depending on an internal state and an external state of the vehicle. Therefore, the present invention is made to achieve an object to provide a vehicle in which a color of a body can be automatically changed depending on an internal state and an external state of the vehicle.

### Means for Solving the Problems

A vehicle of the present invention for achieving the aforementioned object includes: a detection device that detects an internal state and an external state of the vehicle; and a color change device that at least partially changes a color of a body of the vehicle depending on a result of detection by the detection device.

In the vehicle of the present invention constituted as above, when the detection device detects the internal state and the external state of the vehicle, the color change device at least partially changes the color of the body of the vehicle depending on the result of the detection. Therefore, in the vehicle of the present invention, it is possible to automatically change the color of the body depending on the internal state and the external state of the vehicle.

Various configurations can be considered as a configuration of the detection device and a configuration of the color change device. For example, it may be configured such that the detection device detects a color of a surroundings of the vehicle, and the color change device changes the color of the body to, among colors to which the color change device is capable of changing, a color having a greatest difference in one of color and brightness, compared with the detected color of the surroundings. In this case, since the color of the body can be changed to the color having the greatest difference in the one of color and brightness compared with the color of the surroundings of the vehicle, the vehicle can be made easily noticeable and therefore, occurrence of accidents, etc. can be suppressed. That is, conventionally, there has been a problem in which the color of the body is desired to be automatically changed to a color easily noticeable from the color of the surroundings; however, in this configuration, such a problem can be solved.

Moreover, the detection device may detect an operational state of an operation unit provided inside the vehicle, and the color change device may change the color of the body to a predetermined color depending on the detected operational state. In this case, when the operation unit provided inside the vehicle is operated, the color change device changes the color of the body to the predetermined color depending on the detected operational state. Therefore, it is possible to automatically change the color of the body to a predetermined desired color by operating the operation unit as desired by a driver or a fellow passenger. That is, conventionally, there has been a problem in which the color of the body is desired to be freely changed by operation inside the vehicle; however, in this configuration, such a problem can be solved.

Furthermore, the detection device may detect a physical feature of the driver, and the color change device may change the color of the body to a predetermined color depending on the detected physical feature. In this case, if the driver is changed to another driver, the color change device changes the color of the body to the predetermined color depending on a physical feature of the another driver. For this reason, in a case where multiple drivers share one vehicle, a desired color by each of the drivers is predetermined. Thereby, when one of the drivers drives the vehicle, the color of the body can be automatically changed to the predetermined color for the one of the drivers. That is, conventionally, there has been a problem in which the color of the body is desired to be automatically changed as desired by each driver; however, in this configuration, such a problem can be solved.

Still further, the detection device may detect a surrounding weather of the vehicle, and the color change device may change the color of the body to a predetermined color depending on the detected surrounding weather. In this case, the color of the body can be automatically changed to the predetermined color depending on the surrounding weather. Therefore, for example, if the color of the body is preset to be changed to a color with which a temperature is not likely to increase, in weather that is likely to increase a temperature of the vehicle, it is possible to desirably inhibit a temperature increase inside the vehicle. Moreover, if the color of the body is preset to be changed to a noticeable color in weather with poor visibility such as fog, occurrence of accidents, etc. can be suppressed. That is, conventionally, there has been a problem in which the color of the body is desired to be automatically changed depending on weather; however, in this configuration, such a problem can be solved.

The detection device may detect a presence or absence of a fellow passenger other than the driver, and the color change device may change the color of the body to a predetermined color depending on the detected presence or absence of the fellow passenger. In this case, the color of the body can be changed to the predetermined color depending on the presence or absence of the fellow passenger. For this reason, how the vehicle is viewed from outside can be made different depending on the presence or absence of the fellow passenger. That is, conventionally, there has been a problem in which the color of the body is desired to be automatically changed depending on the presence or absence of a fellow passenger; however, in this configuration, such a problem can be solved.

Furthermore, the body may include a steel plate, an outer surface of the steel plate being painted in a first color. The color change device may include: a color change layer that is layered with the outer surface of the steel plate and reversibly-changes a color thereof, depending on a temperature, between a second color that is different from the first color and being transparent; a heater that is layered with an inner surface of the steel plate and heats the color change layer; and a controller that controls heating and not-heating by the heater.

In this case, depending on whether the controller heats the color change layer via the heater or does not heat the color change layer, the color change layer is changed to the second color or to be transparent. If the color change layer is changed to the second color, the color of the body becomes the second color. The steel plate, the outer surface of which is painted in the first color, is layered with an inner surface of the color change layer; therefore, if the color change layer is changed to be transparent, the color of the body becomes the first color. Accordingly, switching the aforementioned heating and non-heating via the controller makes it possible to change the color of the body to the first color or the second color. By adopting such a configuration, changing of the color of the overall body can be facilitated.

### BRIEF DESCRIPTION OF THE DRAWINGS

FIGS. 1A to 1C are views showing a configuration of a vehicle to which the present invention is applied, in which FIG. 1A is a perspective view of the vehicle when viewed from a front side thereof, FIG. 1B is a perspective view of the vehicle when viewed from a back side thereof, and FIG. 1C is an exploded perspective view of a body.

FIG. 2 is a block diagram showing a configuration of a control system of the vehicle.

FIG. 3 is a flowchart showing a process executed by the control system.

FIG. 4 is a flowchart showing a modified example of the process executed by the control system.

FIG. 5 is a flowchart showing a further modified example of the process executed by the control system.

FIG. 6 is a block diagram showing a configuration of the control system according to a first modified embodiment.

FIG. 7 is a flowchart showing a process executed by the control system according to the first modified embodiment.

FIG. 8 is a flowchart showing a modified example of the process executed by the control system according to the first modified embodiment.

FIG. 9A is a flowchart showing a modified example of the process executed by the control system according to the first modified embodiment, and FIG. 9B is a flowchart showing a modified example of a process executed by the control system according to a second modified embodiment.

FIG. 10 is a block diagram showing a configuration of the control system according to the second modified embodiment.

FIG. 11 is a flowchart showing the process executed by the control system according to the second modified embodiment.

### EXPLANATION OF REFERENCE NUMERALS

1 . . . vehicle, 1B . . . body, 3 . . . nose camera, 5 . . . back camera, 11 . . . steel plate, 12 . . . nichrome heater, 13,17 . . . color change layer, 16 . . . film heater, 30 . . . controller, 31 . . . touch panel, 32 . . . temperature sensor, 33 . . . battery monitor, 34 . . . fingerprint sensor, 35 . . . fellow passenger sensor

### MODE FOR CARRYING OUT THE INVENTION

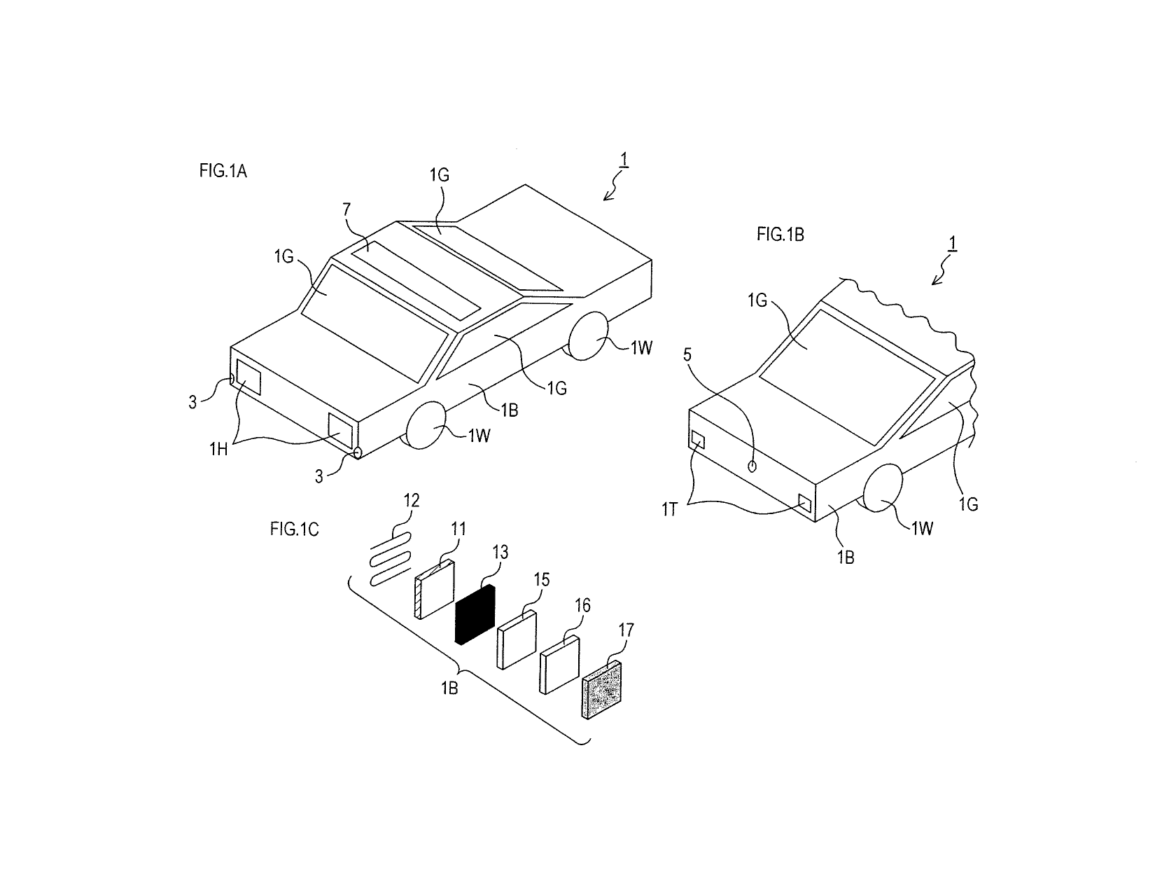

An embodiment of the present invention will be described with reference to the drawings. FIGS. 1A and 1B are perspective views showing a configuration of a vehicle 1 to which the present invention is applied. FIG. 1A is a perspective view of the vehicle 1 when viewed from a front side thereof. FIG. 1B is a perspective view of the vehicle 1 when viewed from a back side thereof. As shown in FIGS. 1A and 1B, the vehicle 1 is a sedan-type automobile with four wheels 1W. Head lights 1H and tail lamps 1T are, respectively, mounted on a front-end surface and a rear-end surface of the vehicle 1. A body 1B is an overall steel plate part of an outer circumferential surface, which excludes the wheels 1W, the head lights 1H, the tail lamps 1T, and glass parts 1G, of the vehicle.

On both a right-side end and a left-side end of the front-end surface of the vehicle 1, a pair of nose cameras 3 for capturing an image of a so-called nose view are mounted. On a central part of the rear-end surface of the vehicle 1, one back camera 5 for capturing an image of a so-called back view is mounted. Furthermore, a photovoltaic panel 7 is mounted on a top end surface of the vehicle 1, and electricity generated by the photovoltaic panel 7 is used to charge a battery, which is not illustrated in the figures.

FIG. 1C is an exploded perspective view showing a configuration of the body 1B in detail. As shown in FIG. 1C, the body 1B includes a steel plate 11, an entire part of which is formed by press-molding depending on an outer shape of the vehicle 1. Layered with an inner surface of the steel plate 11 is a nichrome heater 12. An outer surface of the steel plate 11 is painted in white, and such a surface of the steel plate 11 is layered with a color change layer 13. The color change layer 13 is black at normal temperature and becomes reversibly-transparent when heated (for example, 50° C.). Moreover, a surface of the color change layer 13 is layered with a transparent resin layer 15 having an excellent heat-insulating property. A surface of the transparent resin layer 15 is layered with a transparent film heater 16. Furthermore, a surface of the film heater 16 is layered with a color change layer 17. The color change layer 17 is red at normal temperature, and becomes reversibly-transparent when heated (for example, 50° C.).

As the color change layers 13 and 17, a known technique using thermochromic inks, such as techniques disclosed in Unexamined Japanese Utility Model Application Publication No. H5-5482 and Unexamined Japanese Patent Application Publication No. 2009-282169, can be used. As the film heater 16, for example, a commercially available product manufactured by SANKO NAME Co. Ltd. can be used.

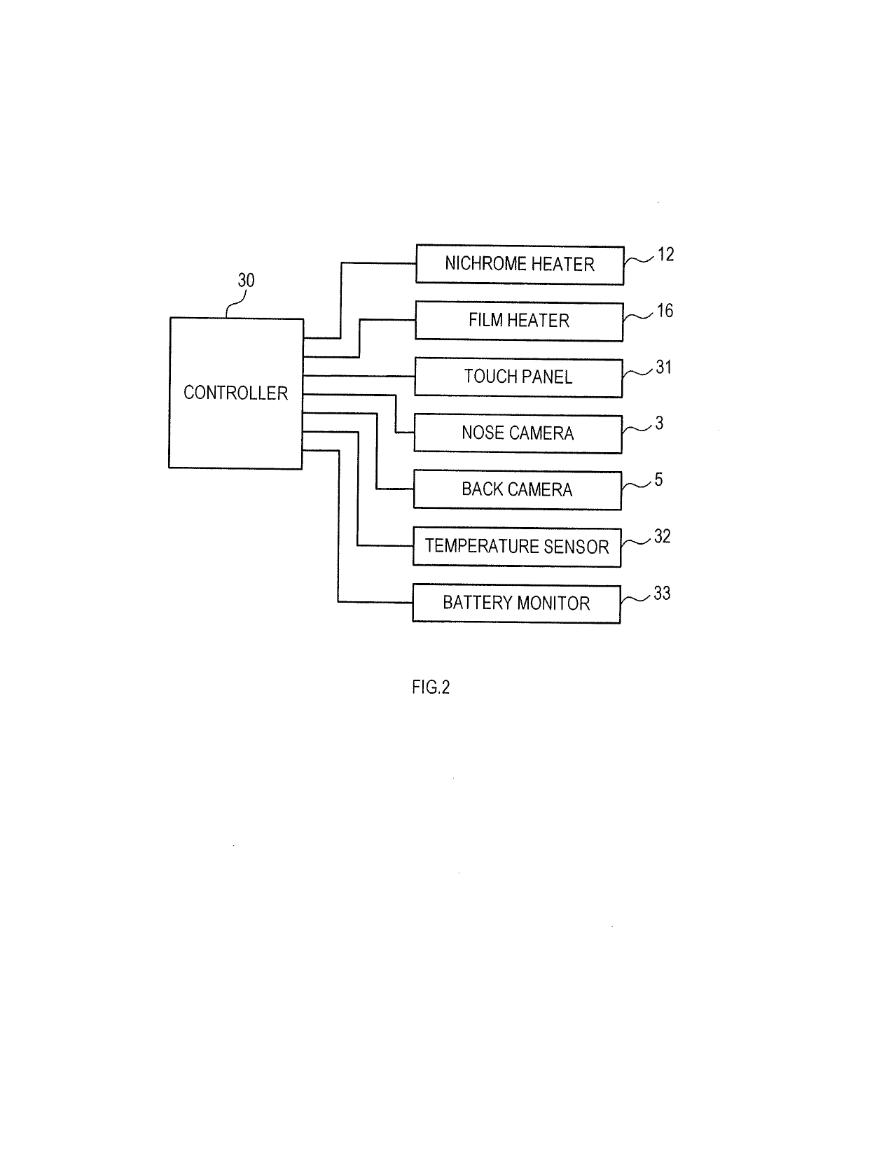

FIG. 2 is a block diagram showing a configuration of a control system of the vehicle 1. As shown in FIG. 2, the control system is mainly composed of a controller 30, which is provided with a microcomputer including a CPU, a ROM, a RAM, and an NVRAM. Connected to the controller 30 are the nose camera 3 (although both of the nose cameras 3 are connected, only one of which is shown as a representative), the back camera 5, the nichrome heater 12, and the film heater 16. Moreover, a touch panel 31, a temperature sensor 32, and a battery monitor 33 are connected to the controller 30. The touch panel 31 is installed in a vicinity of a driver's seat inside the vehicle and also functions as a display unit of a car navigation system. The temperature sensor 32 measures a temperature outside the vehicle. The battery monitor 33 detects a remaining charge of the aforementioned battery.

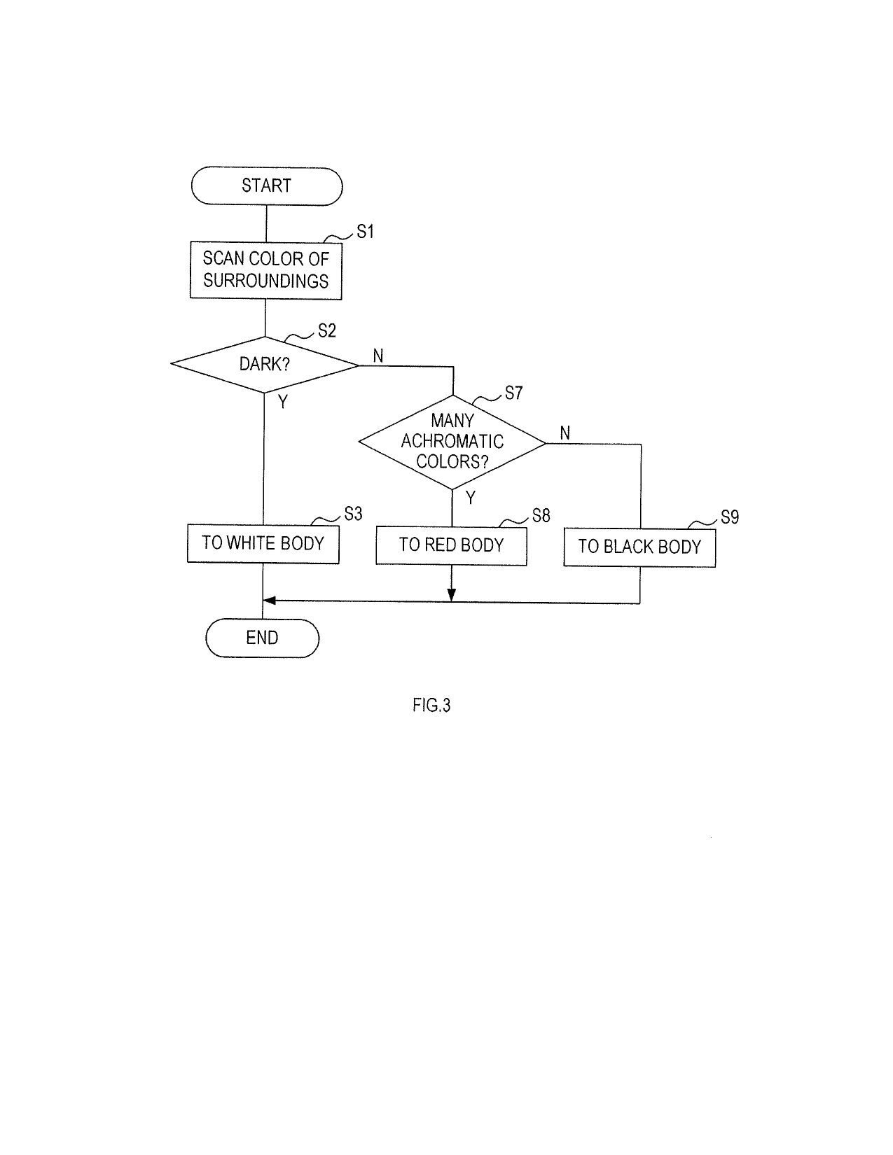

Next, a process executed by the controller 30 will be explained by using a flowchart in FIG. 3. Here, the CPU of the controller 30 repeatedly executes this process based on a program stored in the ROM when an ignition key of the vehicle 1 is in an accessory position or ON position.

As shown in FIG. 3, in this process, first in S1 (S represents a step: the same applies hereinafter), the controller 30 scans colors of the surroundings via the pair of nose cameras 3 and the back camera 5. Although this scanning of the colors may be performed by simply calculating an average value of colors in the image captured by the nose cameras 3 and the back camera 5, it is also considered to improve accuracy in the following manner.

For example, an image processing, such as edge treatment, is performed on the image captured by the nose cameras 3 and the back camera 5 so as to extract an elongated object, such as a guardrail and a white line on a road-side zone. Then, it may be configured such that a part of the image located inward from the elongated object (i.e., a part closer to the vehicle 1) is ignored as an image of a road, and an average value of colors in a part of the image located outward from the elongated object is calculated. In this case, it is possible to calculate colors that more favorably reflect colors of the outer surroundings in a horizontal direction of the vehicle.

Moreover, the scanning of the colors of the surroundings is not limited to a configuration in which the nose cameras 3 and the back camera 5 are used as in the present embodiment, but may be performed by providing, in the vehicle 1, a particular camera for detecting colors of surroundings, for example, a camera for imaging Street View, which is provided by the internet search engine Google (Registered Trademark). Furthermore, the image captured via the nose cameras 3 and the back camera 5 is not always displayed on the touch panel 31, but displayed as needed in the same manner as in a commercially available automobile. Such switching of display may be performed by the controller 30.

After the colors of the surroundings are scanned in S1 as described above, in the subsequent S2, the controller 30 compares an average brightness of the scanned colors with a predetermined threshold value to determine whether or not the colors of the surroundings are dark. If the colors of the surroundings are dark (S2: Y), the process proceeds to S3 and the controller 30 energizes both the nichrome heater 12 and the film heater 16 to make both the color change layers 13 and 17 be transparent, thereby changing a color of the body 1B to white. Then, the present process is suspended. As a result, even if a surrounding environment is dark due to night time or bad weather conditions, the vehicle 1 is easily noticeable as the vehicle 1 is white. Consequently, occurrence of accidents, etc. can be suppressed.

On the other hand, if the colors of the surroundings are not dark (S2: N), the process proceeds to S7 and the controller 30 compares an average intensity of the scanned colors with a predetermined threshold value to determine whether or not there are many achromatic colors in the colors of the surroundings. If there are many achromatic colors (S7: Y), the process proceeds to S8 and the controller 30 stops energizing both the nichrome heater 12 and the film heater 16 to change the color of the body 1B to red. Then, the present process is terminated. As a result, even if fog is generated in the surroundings, even if driving is performed through an industrial area with many black buildings, or if a view of the surroundings is a snowy landscape, the color of the body 1B is made to be red, which is easily-noticeable. Thereby, occurrence of accidents, etc. can be suppressed.

On the other hand, if there are not many achromatic colors in the surroundings (S7: N), the process proceeds to S9 and the controller 30 stops energizing the nichrome heater 12 but energizes the film heater 16 to change the color of the body 1B to black. Then, the present process is terminated. As a result, even if the surroundings are a bustling downtown area, etc. and include many loud colors, the color of the body 1B is made to be black, which is easily noticeable. Thereby, occurrence of accidents, etc. can be suppressed.

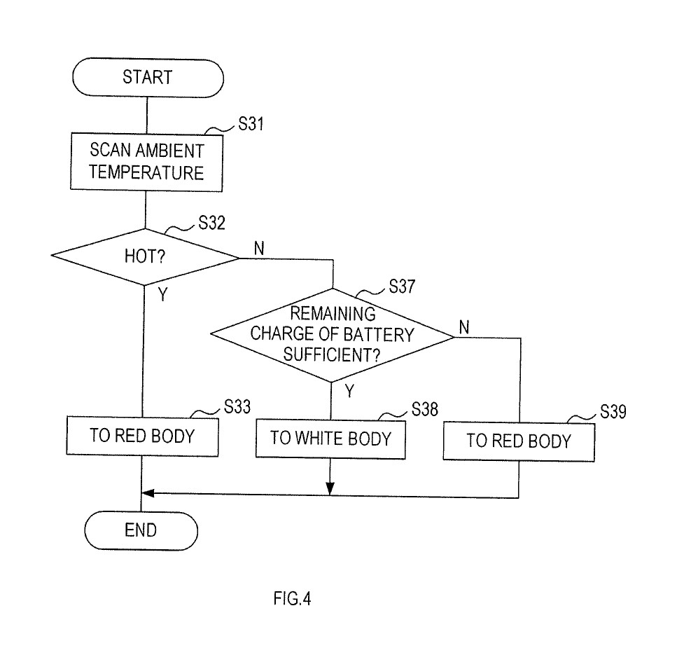

The controller 30 may execute a process as shown in FIG. 4 when the vehicle 1 is parked in which the ignition key of the vehicle 1 is not inserted. In this process, first in S31, the controller 30 scans an ambient temperature via the temperature sensor 32. In the subsequent S32, the controller 30 compares the temperature with a predetermined threshold value to determine whether or not it is hot. If it is not hot (S32: N), the process proceeds to S33 and the controller 30 stops energizing both the nichrome heater 12 and the film heater 16 to change the color of the body 1B to red. Then, the present process is terminated. As a result, consumption of electric power during parking can be suppressed.

On the other hand, if it is hot (S32: Y), the process proceeds to S37 and the controller 30 determines whether or not a remaining charge of the battery is sufficient via the battery monitor 33. If the remaining charge is sufficient (S37: Y), the process proceeds to S38 and the controller 30 energizes both the nichrome heater 12 and the film heater 16 to change the color of the body 1B to white. Then, the present process is suspended. Consequently, it is possible to suppress a temperature increase inside the vehicle by reflecting sunlight, etc. pouring on the vehicle 1. Moreover, if it is hot (S32: Y), there are many cases where a power generation amount by the photovoltaic panel 7 is large; therefore, even if both the nichrome heater 12 and the film heater 16 are energized in the above-described manner, it is possible to suppress a decrease in the remaining charge of the battery. Furthermore, in the case that the remaining charge of the battery is sufficient, in parallel with this process, a process, such as operating a power window to create a gap in a window and rotating a fan at a low speed to ventilate air, may be executed.

If it is hot and the remaining charge of the battery is not sufficient (S32: Y, S37: N), the process proceeds to S39 and the controller 30 stops energizing both the nichrome heater 12 and the film heater 16 to change the color of the body 1B to red. Then, the present process is terminated. As a result, consumption of electric power during parking can be suppressed. Here, in parallel with this process, a process to stop supply of electric power to the controller 30 may be executed.

As explained above, in the present embodiment, the color of the body 1B is changed depending on the colors of the surroundings (including weather such as fog) and the temperature of the vehicle 1; thereby, it becomes possible to suppress occurrence of accidents, etc. by making the vehicle 1 be easily noticeable and suppress the temperature increase inside the vehicle.

Here, the present invention should not be limited to the above-described embodiment at all and can be implemented in various manners without departing from the spirit of the present invention. For example, the color of the body 1B may be changeable to a color other than the aforementioned white, red, and black, and also may be changeable to either of two colors. Moreover, processes (S37 to S39) for changing the color of the body 1B depending on the remaining charge of the battery may be executed during running of the vehicle 1. In this case, it is possible for a driver of a vehicle near the vehicle 1 to recognize the vehicle 1 that appears to be almost stopping due to decrease of the remaining charge of the battery. Furthermore, in such a case, it is desirable to change the color of the body 1B to a color that is considered to be obviously abnormal in the surroundings, for example, to change the color of the body 1B to red and black in an alternating manner. Moreover, such a control exhibits a more significant effect if the vehicle 1 is an electric vehicle.

The control of notifying an abnormality to the surroundings by changing the color of the body 1B as described above can be applied in a case where an abnormality, such as a malfunction, etc., occurs in the vehicle. For example, when a malfunction of the vehicle 1 is detected by a malfunction detection sensor (corresponding to an example of a detection device), the color of the body 1B may be changed to a color that is considered to be abnormal in the surroundings, as described above. Such a process can be achieved by connecting the malfunction detection sensor to the controller 30 and, during running of the vehicle, executing the processes of S37 to S39 in which in S37, it is determined “whether or not a malfunction is detected” and in S39, the color of the body 1B is changed to red and black in an alternating manner.

In a case where the vehicle 1 is a vehicle equipped with an internal-combustion type engine, as the aforementioned malfunction detection sensor, there are various known sensors, including a malfunction detection sensor as described in Japanese Unexamined Patent Application Publication No. 2010-507761, etc., which detect a malfunction, such as the following: a detected value by a water temperature sensor is equal to or more than a predetermined value; an amount of water for cooling is equal to or less than a predetermined value; an amount of engine oil is equal to or less than a predetermined value; an oil temperature is equal to or more than a predetermined value, and a remaining amount of gasoline is equal to or less than a predetermined value. Moreover, as a sensor that can be applied in a case where the vehicle 1 is an electric vehicle, there is a sensor that detects that a remaining amount of electricity in the battery is equal to or less than a predetermined value as described above. As a sensor that can be applied to the vehicle 1 regardless of whether the vehicle 1 is an electric vehicle or a vehicle equipped with an internal-combustion type engine, there are various known sensors that detect a malfunction, such as a remaining amount of a brake pad or a rotor is equal to or less than a predetermined value, or an amount of brake fluid is equal to or less than a predetermined value.

Furthermore, an embodiment in which the color of the body 1B is changed to the color that is considered to be abnormal in the surroundings in the above explained manner, exhibits effects in suppression of crimes, etc. using the vehicle 1. For example, it may be configured as follows: a receiver (corresponding to an example of the detection device) for receiving a specific radio wave transmitted from a police vehicle such as a patrol car is connected to the controller 30; and when the receiver receives the aforementioned special radio wave, the color of the body 1B may be changed to the aforementioned color that is considered to be abnormal. In short, a function of changing the color of the body 1B upon receipt of a specific type of radio wave is provided. In this case, the police vehicle transmits the aforementioned specific radio wave toward the vehicle 1 that is running away so as to change the body 1B of the vehicle 1 to the aforementioned color that is considered to be abnormal; consequently, chasing can be facilitated. Moreover, as a vehicle-theft suppression measure, when the vehicle 1 is running and receives a radio wave of a keyless entry system corresponding to the vehicle 1, the color of the body 1B may be changed to the aforementioned color that is considered to be abnormal. In this case, an owner of the vehicle 1, which is stolen before the owner's very eyes, transmits a radio wave of a keyless entry system toward the vehicle 1, to change the color of the body 1B of the vehicle 1 to the aforementioned color that is considered to be abnormal. Thereby, chasing can be facilitated.

Moreover, as a control to change the color of the body 1B upon receipt of the specific radio wave in the above-described manner, further various embodiments can be considered. For example, friends transmit specific radio waves to each other, and upon receipt of the radio wave, the color of the body 1B may be changed to a same color, which is predetermined among the friends.

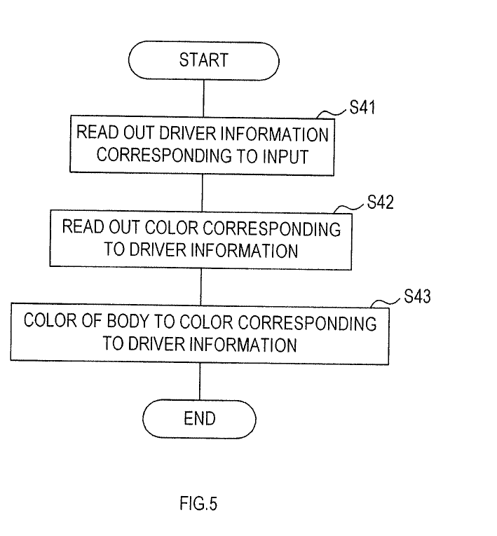

Furthermore, a following technique has been already put to practical use: drivers, such as a father, a mother, a daughter, etc., are mapped to respective angles of a mirror, etc. and such mapping is stored beforehand; when a button for indicating a driver is pressed, the angle, etc. of the mirror is automatically adjusted to the angle corresponding to such a driver. In this regard, if the aforementioned button for indicating a driver is provided in the aforementioned touch panel 31, the controller 30 may repeatedly execute a process as shown in FIG. 5 when the ignition key of the vehicle 1 is in the accessory position or ON position.

As shown in FIG. 5, in this process, first in S41, the controller 30 reads out driver information corresponding to an input to the touch panel 31. In the driver information, among red, white, and black, a desired color by the driver is pre-mapped and recorded in the NVRAM of the controller 30. In the subsequent S42, the controller 30 reads out, from the NVRAM, the color corresponding to the driver information read in S41. In S43, the color of the body 1B is changed to the read-out color. Then, the present process is terminated.

In the aforementioned case, the color of the body 1B can be automatically changed to the desired color which is preset to the driver. In this case, the controller 30 may execute, in parallel with the aforementioned automatic change of the color of the body 1, the process for adjusting the angle, etc. of the mirror depending on the driver information as described above. Moreover, if the driver or a fellow passenger presses a button indicating another driver in the touch panel 31, it becomes possible to change the color of the body 1B freely, as desired, by an operation performed inside the vehicle during, for example, running of the vehicle 1. In this case, however, it is preferable not to execute the above-described process for adjusting the angle, etc.

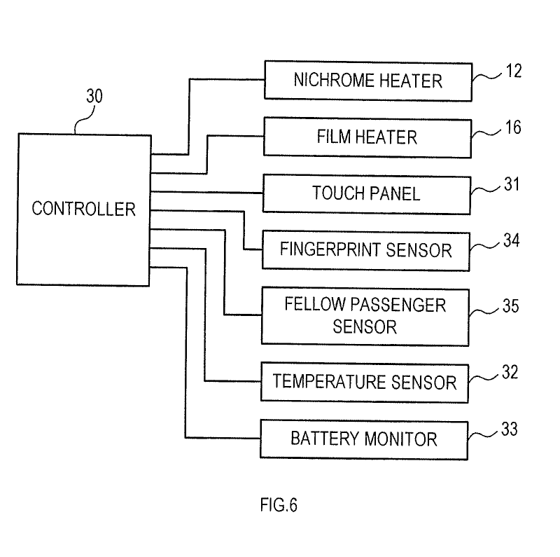

Furthermore, instructions from the driver such as instructions described above may be automatically made by detecting physical features of the driver. FIG. 6 is a block diagram showing a configuration of a control system in a first modified embodiment which corresponds to a control as such. As shown in FIG. 6, this control system is configured in the same manner as the control system in FIG. 2, except for the following differences: instead of the nose cameras 3 and the back camera 5, a fingerprint sensor 34 and a known fellow passenger sensor 35 are connected to the controller 30; the fingerprint sensor 34 is provided in a steering wheel and detects fingerprints of the driver, and the fellow passenger sensor 35 detects a presence or absence of a fellow passenger in a passenger seat.

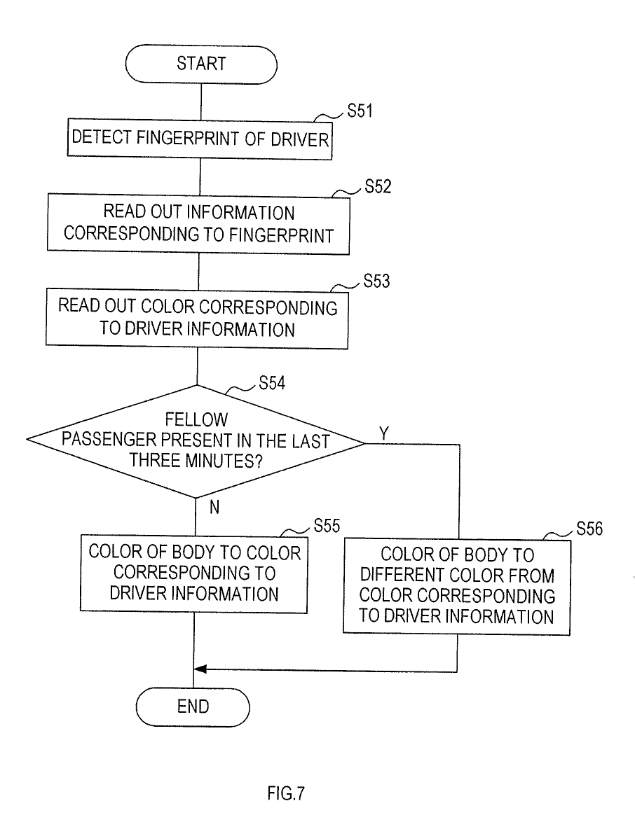

FIG. 7 is a flowchart showing a process to be repeatedly executed by this control system. As shown in FIG. 7, in this process, first in S51, the controller 30 detects fingerprints of the driver via the fingerprint sensor 34. In the subsequent S52 and S53, the controller 30 reads out driver information corresponding to fingerprint information (S52) in the same manner as in the aforementioned S41 and S42, and then reads out a color corresponding to the driver information (S53). Next, in S54, the controller 30 determines whether or not a fellow passenger is present in the last three minutes with reference to results of detection by the fellow passenger sensor 35. If a fellow passenger is not present in the last three minutes (S54: N), the process proceeds to S55 and the controller 30 changes the color of the body 1B to the color read out in S53. Then, the present process is terminated. Accordingly, the color of the body 1B can be automatically changed to the desired color, which is preset to the driver, in the same manner as the above-described process in FIG. 5. Moreover, in the present embodiment, it is not necessary for the driver to operate the touch panel 31. In the present embodiment, the driver holds the steering wheel and the driver's own fingerprints are detected by the fingerprint sensor 34; thereby, the color of the body 1B can be automatically changed to the aforementioned desired color. Here, instead of the fingerprints, other physical features may be detected to identify the driver.

On the other hand, if a fellow passenger is present in the last three minutes (S54: Y), the process proceeds to S56 and the controller 30 changes the color of the body 1B to a different color from the color corresponding to the driver information read out in S53. Then, the present process is terminated. The different color may be pre-fixed in the following manner; for example, if the color corresponding to the driver information is red, the different color is black. Moreover, the driver may be able to set the different color in an appropriate manner. By this process, the following effect is generated in the present embodiment.

For example, in a case where the driver is a male and has to allow a young woman to sit in the passenger seat due to work commitments, etc., if such a scene is spotted by an acquaintance, this acquaintance may have a misleading suspicion. In the present embodiment, if the fellow passenger is present (S54: Y), the color of the body 1B is changed to the different color from the normal color corresponding to the driver information (S56). Accordingly, people outside the vehicle would consider the vehicle as a different vehicle, and therefore, it is possible to suppress in advance arising of the suspicion described above. Furthermore, the color of the body 1B that has been changed to the aforementioned different color remains unchanged for three minutes (which may be other predetermined time periods) after the fellow passenger alights. Therefore, even if an acquaintance spots a scene where the driver is greeting the fellow passenger who got out of the vehicle, arising of the suspicion described as above can be suppressed in advance.

Such a control as above may be applied to a taxi. In this case, a customer who is trying to catch a taxi can determine whether or not the taxi is vacant based on the color of the body 1B. In such a case, it is desirable that in S54, whether or not the fellow passenger is present is determined at such a point in time (within the last zero minutes). Moreover, in such a case, in the processes of S53 and S55, the color of the body 1B may be changed to a color corresponding to a level of the driver's skills.

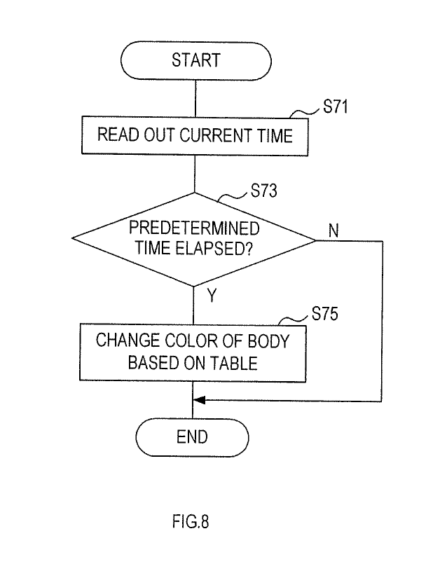

In any of the above-described control systems, the color of the body 1B may be changed depending on a time as described below. FIG. 8 is a flowchart showing such a process. As shown in FIG. 8, in this process, first in S71, the controller 30 reads out a current time from a clock provided therein. In the subsequent S73, the controller 30 determines whether or not a pre-set predetermined time (for example, 1 hour) has elapsed, from a time when the color of the body 1B is changed at a previous time or a time when an engine is stared. If the predetermined time has not elapsed (S73: N), the controller 30 simply suspends the present process. If the predetermined time has elapsed (S73: Y), in S75, the color of the body 1B is changed based on a table stored in the NVRAM, and then, the present process is suspended.

That is to say, in the table, an order based on which the color of the body 1B should be changed is stored. In this process, it is possible to change the color of the body 1B in the order stored in the table, each time when the predetermined time has elapsed (S73: Y). By the same process, the color of the body 1B may be changed as follows: the color of the body 1B may be changed between day and night, for example, between 6 o'clock to 18 o'clock, and 18 o'clock to 6 o'clock of the next day; the color of the body 1B may be changed every week; or the color of the body 1B may be changed depending on seasons, i.e., what month it currently is.

Furthermore, if the process in S73 is configured to be a process of determining whether a predetermined time has elapsed from a time of a previous parking of the vehicle 1, the following control becomes possible. Specifically, if driving is performed continuously on a highway, etc. without taking a break, a risk of falling asleep while driving, etc. increases. Therefore, if the color of the body 1B is changed such that: up to two hours from the previous parking, the color is to be blue; from two hours up to three hours from the previous parking, the color is to be yellow; and after three hours or more from the previous parking, the color is to be red, it is possible to inform reliability of driving of the vehicle 1 to drivers around the vehicle 1. Furthermore, in this case, in order to distinguish an original color of the vehicle 1, a part of the body 1B, for example, only a roof part of the vehicle 1, may be changed in the above-described manner or changed to the aforementioned color that is considered to be abnormal.

Moreover, in the controls of the respective embodiments described above, it may be configured such that any desired one of the controls can be executed by mode setting of the driver; alternatively, it may be possible to select, without performing any controls, a mode in which the color of the body 1B is not changed. As a mode for changing a color of the part of the body 1B, various modes can be considered, such as making a right half, a left half, an upper half, a lower half, or a middle part of the body 1B have a design of lines. As described above, as a mode of changing the color of the part of the body 1B, it may be configured such that an operational state of a directional indicator by the driver is detected (corresponding to an example of the detection device) to change a color of the right half or the left half of the body 1B in the same manner as a lamp of the directional indicator. Furthermore, it may be configured such that by detecting an operational state of a brake pedal by the driver (corresponding to an example of the detection device), if the brake pedal is operated, a color of a rear end of the body 1B, a color of a front part and a rear part of the body 1B, or a color of the entire body 1B is changed. In a case where a color of a forward part of the body 1B is changed while the brake pedal is operated, it is possible for a driver of an oncoming vehicle from a forward direction of the vehicle 1 to notice that the brake pedal is being operated in the vehicle 1, and therefore, it is possible to notify the driver of the oncoming vehicle that the driver of the vehicle 1 is trying to give way to a vehicle turning right, etc.

Moreover, various modes can be considered as a device that changes the color of the body 1B. For example, the color of the body 1B may be changed by attaching an electrochromic element as disclosed in Japanese Unexamined Patent Application Publication No. H6-90828 onto a surface of the body 1B. Alternatively, the color of the body 1B may be changed by attaching an electroluminescence element (EL element) onto the surface of the body 1B. In a case where the color of the body 1B is changed by utilizing an element capable of freely changing a color thereof to various colors as in a color liquid crystal display, it becomes possible to achieve a control, for example, changing the color of the body 1B to a color opposite the color of the surroundings. Furthermore, in this case, it may be configured such that by connecting a known vehicle speed sensor or a sensor for detecting wind pressure which the vehicle 1 receives while running (both of which correspond to an example of the detection device) to the controller 30, an image to be displayed on the body 1B is changed depending on a vehicle speed or wind pressure detected respectively by these sensors.

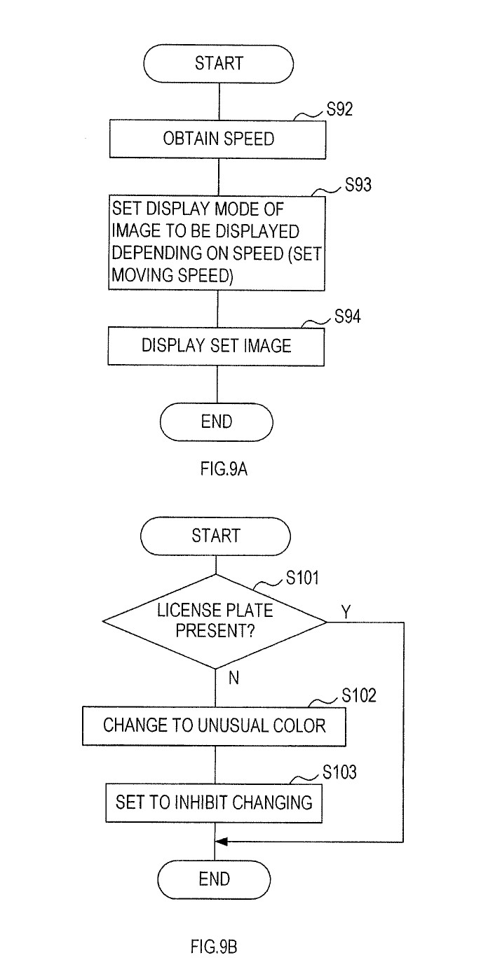

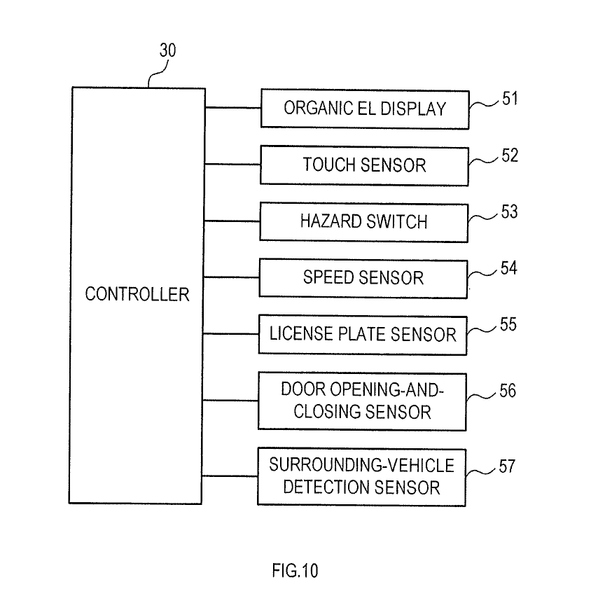

Specifically, as shown in a flowchart of FIG. 9A, it is to be configured that a sensing value is first obtained by the vehicle speed sensor (a speed sensor 54 shown in FIG. 10, etc.) (S92), then, a display mode of an image to be displayed is set depending on a speed (S93), and thereafter, an image is displayed in the set mode (S94).

The image to be displayed in this process can be, for example, an image showing a flame waving in the wind, which is to be displayed on the body 1B, during running at a high speed, which is a predetermined speed or more, or an image in which, as the speed becomes faster, a moving speed of a striped pattern (e.g., a speed of moving from a front side to a rear side) is made to be faster. If the image showing the flame waving in the wind is displayed, it is desirable to change the display of such an image depending on a vehicle speed such that as the vehicle speed is faster, the flame waves more intensely.

Moreover, it may be configured such that a predetermined image (for example, an image of the striped pattern, a checkerboard pattern, etc.) is moved from a front side to a rear side of the vehicle 1 depending on the speed, and in this case, as a running speed of the vehicle is faster, the moving speed of the image is made to be faster.

Furthermore, the controls shown in FIGS. 3 and 4, etc. may be performed by using a known rain drop sensor or a solar-radiation amount sensor for automatically controlling windshield wipers. Still further, the present invention should not be limited to a vehicle as an automobile, and can be applied to vehicles such as a motor scooter, a bicycle, a cart, and so on in the same manner.

In a case where the electroluminescence element (EL element) is attached to the surface of the body 1B, a configuration shown in FIG. 10 can be adopted. FIG. 10 is a block diagram showing a control system of a second modified embodiment.

As shown in FIG. 10, the control system (the vehicle 1) of the second modified embodiment includes the controller 30, an organic EL display 51, a touch sensor 52, a hazard switch 53, the speed sensor 54, a license plate sensor 55, a door opening-and-closing sensor 56, and a surrounding-vehicle detection sensor 57.

The organic EL display 51 is a known display including the electroluminescence element, and is arranged on an overall surface (which may be a region excluding a part such as a glass surface, etc.) of the body 1B of the vehicle 1. The controller 30 has a function as an image display driver that controls an image displayed on the organic EL display 51, and displays any image on the body 1B.

The touch sensor 52 is disposed on the organic EL display 51, and is constituted as a sensor that reacts when the organic EL display 51 is touched. As this touch sensor 52, not only a general capacitance type sensor, but also a pressure sensitive type sensor which can detect a wind pressure during driving, can be adopted. The speed sensor 54 is constituted as a known sensor that detects a running speed of the vehicle 1.

The license plate sensor 55 detects an attachment state of a license plate (i.e., whether the license plate is attached or detached). Specifically, it is possible to adopt, for example, the following configurations: a configuration in which a magnetic field is generated in a vicinity of the license plate, and the presence or absence of the license plate is detected based on a change in the magnetic field; a configuration in which an IC chip is embedded in the license plate, and the presence or absence of the license plate is detected based on whether or not information in the IC chip can be read; and a configuration in which the presence or absence of the license plate is detected by an optical sensor.

As the door opening-and-closing sensor 56, a known sensor that detects an open state or a closed state of a door of the vehicle 1 can be adopted. The surrounding-vehicle detection sensor 57 is a sensor that detects other vehicles surrounding the vehicle 1. As the surrounding-vehicle detection sensor 57, a configuration of detecting a vehicle by a known SONAR (sound navigation and ranging), a radar, or an image processing sensor can be adopted.

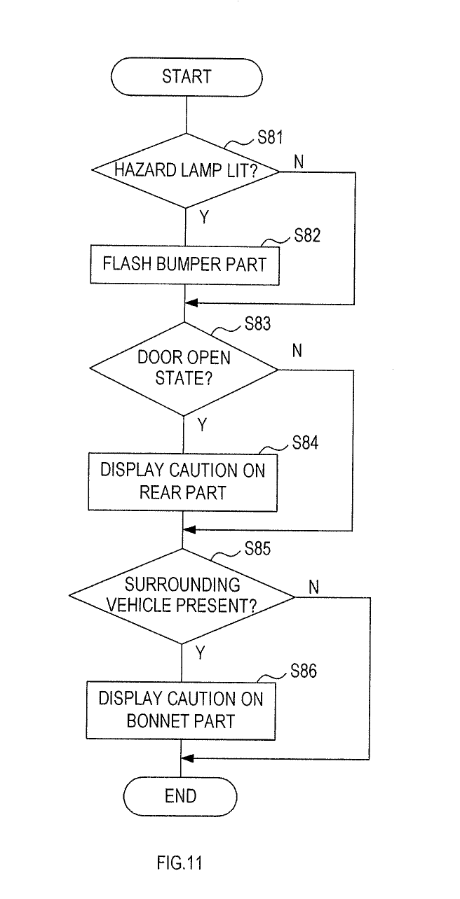

In the configuration of the second modified embodiment as described above, the controller 30 can perform a process as shown in a flowchart of FIG. 11. This process is, for example, a process that is started when the vehicle 1 is powered on and thereafter, repeatedly executed.

In this process, it is first determined whether or not a hazard lamp is lit (S81). In such a process, a state of the hazard switch 53 is detected, and if the hazard switch 53 is in an ON state, it is determined that the hazard lamp is lit.

If the hazard lamp is not lit (S81: N), the process immediately proceeds to S83, which will be described later. If the hazard lamp is lit (S81: Y), the organic EL display 51 disposed on a bumper part of the vehicle 1 is made to flash (S82).

In this case, a mere orange region or a mere red region may be flashed, or an image of characters such as “Parked” or “Watch Out”, etc. may be generated and displayed (flashed). In such a case, a flashing cycle of the hazard lamp may be synchronized with a flashing cycle of the image (region).

Moreover, contents to be displayed or contents to be flashed may be changed depending on a location or a speed of the vehicle during running. For example, during running on a highway (it is possible to obtain information from a known navigation system), if the hazard lamp is turned on while the speed is being decelerated, it is preferable to display characters such as “Caught in Traffic Jam” or “Watch Out for Rear-End Collision”, etc. in a rearward direction of the vehicle.

Subsequently, the open state or the closed state of the door is determined (S83). The open state or the closed state of the door is determined based on a sensing result by the door opening-and-closing sensor 56. If the door is in the closed state (S83: N), the process immediately proceeds to a process of S85, which will be described later.

On the other hand, if the door is in the open state (S83: Y), an indication for giving a caution (lighting and flashing, etc. of the image) is displayed on the organic EL display 51 disposed at a rear part of the vehicle 1 (S84). Then, a presence or absence of a surrounding vehicle is determined (S85). The presence or absence of the surrounding vehicle is determined based on a sensing result by the surrounding-vehicle detection sensor 57.

If a surrounding vehicle is not present (S85: N), the present process is immediately terminated. If a surrounding vehicle is present (S85: Y), an image for raising a caution is displayed on the organic EL display 51 disposed on a bonnet part of the vehicle 1 (S86). Since this image is for the driver of the vehicle 1, the image is displayed at a position on the bonnet, which is easily-viewable to the driver. After such processes are completed, the present process is terminated.

In the configuration described in the aforementioned second modified embodiment, in a case where the electroluminescence element (EL element) is attached to the surface of the body 1B, it may be configured such that the electroluminescence element is arranged in part of the body 1B (e.g., a bumper and the bonnet), and the constitution of changing the color of the body 1B described in the aforementioned embodiment is arranged in another part of the body 1B.

Moreover, in the control system of the second modified embodiment, as shown in a flowchart of FIG. 9B, the color of the vehicle may be changed depending on the presence or absence of the license plate. Specifically, as shown in FIG. 9B, first, the presence or absence of the license plate is determined (S101). The presence or absence of the license plate is determined based on a sensing result by the license plate sensor 55.

If the license plate is present (S101; Y), the present process is immediately terminated. If the license plate is not present (S101; N), the color of the body 1B is changed to an unusual color (S102). In this process, the color of the body 1B may be changed to the aforementioned color that is considered to be abnormal, or an image indicating an abnormality may be generated and displayed.

Subsequently, a setting to inhibit changing of the unusual color to other colors by other processes is performed (S103). Then, the present process is terminated.

In each of the above-described embodiments, each of the nose cameras 3, the back camera 5, the touch panel 31, the temperature sensor 32, the battery monitor 33, the fingerprint sensor 34, the fellow passenger sensor 35, and the clock in the controller 30 corresponds to an example of the detection device. Moreover, the touch panel 31 corresponds to an example of an operation unit; each of the nichrome heater 12, the film heater 16, the color change layers 13 and 17, and the controller 30 corresponds to an example of a color change device.

1. A vehicle comprising:
a detection device configured to detect an internal state and an external state of the vehicle; and
a color change device that at least partially changes a color of a body of the vehicle depending on a result of detection by the detection device.

2. The vehicle according to claim 1,
wherein the detection device detects a color of a surroundings of the vehicle, and
wherein the color change device changes the color of the body to, among colors to which the color change device is capable of changing, a color having a greatest difference in one of color and brightness, compared with the detected color of the surroundings.

3. The vehicle according to claim 1,
wherein the detection device detects an operational state of an operation unit provided inside the vehicle, and
wherein the color change device changes the color of the body to a predetermined color depending on the detected operational state.

4. The vehicle according to claim 1,
wherein the detection device detects a physical feature of a driver, and
wherein the color change device changes the color of the body to a predetermined color depending on the detected physical feature.

5. The vehicle according to claim 1,
wherein the detection device detects a surrounding weather of the vehicle, and
wherein the color change device changes the color of the body to a predetermined color depending on the detected surrounding weather.

6. The vehicle according to claim 1,
wherein the detection device detects a presence or absence of a fellow passenger other than a driver, and
wherein the color change device changes the color of the body to a predetermined color depending on the detected presence or absence of the fellow passenger.

7. The vehicle according to claim 1,
wherein the body includes a steel plate, an outer surface of the steel plate being painted in a first color, and
wherein the color change device includes:
a color change layer that is layered with the outer surface of the steel plate, the color change layer reversibly-changing a color thereof, depending on a temperature, between a second color that is different from the first color and being transparent;
a heater that is layered with an inner surface of the steel plate and heats the color change layer; and
a controller that controls heating and not-heating by the heater.
